(19) United States
(12) Patent Application Publication
(10) Pub. No.: US 2012/0100798 A1
(43) Pub. Date: Apr. 26, 2012

(54) DATA CENTER MODULAR INTEGRATED FLOOR DIFFUSER AND ASSEMBLY

(75) Inventors: Pedro J. BERMUDEZ, Olathe, KS (US); Frank A. LEMAY, Sugar Creek, MO (US); Jeffrey L. OTTE, Overland Park, KS (US); David ALSTATT, Lenexa, KS (US); Michael J. MCQUEENY, Leawood, KS (US)

(73) Assignee: KINGSPAN HOLDINGS (IRL) LIMITED, Co Cavan (IE)

(21) Appl. No.: 13/273,848

(22) Filed: Oct. 14, 2011

Related U.S. Application Data
(60) Provisional application No. 61/405,074, filed on Oct. 20, 2010.

(51) Int. Cl. F24F 7/06; F16M 13/02; B23P 17/00

(52) U.S. Cl. 454/338; 29/428; 211/26

(57) ABSTRACT

A floor terminal mounted in a passageway beneath a raised floor utilizing a suspension system is provided. The suspension system includes a grid of interconnected longitudinal and lateral rails. Each of the rails includes an upper wall for supporting a grate assembly or a segment of the raised floor, and a lower wall that has an elongate aperture formed therein. The floor terminal includes a frame that is configured with outwardly extending flanges. A plurality of hook elements are provided for coupling the frame to the rails of the grid. Specifically, each hook element includes an upper angled portion that is inserted through the elongate aperture of one of the rails and rests upon an internal surface of the rail's lower wall. Additionally, each hook element includes a lower-angled portion that engages one of the frame's flanges, thereby suspending the floor terminal within the passageway.

### CROSS-REFERENCE TO RELATED APPLICATIONS

This application claims the benefit of U.S. Provisional Application No. 61/405,074, filed Oct. 20, 2010, entitled “MODULAR INTERGRATED FLOOR DIFFUSER ASSEMBLY,” which is hereby incorporated herein by reference.

### STATEMENT REGARDING FEDERALLY SPONSORED RESEARCH OR DEVELOPMENT

Not applicable.

### BACKGROUND

This invention relates to a system and method for installing a variable air volume floor terminal within a raised floor system. Specifically, embodiments of this invention introduce technology for installing a floor diffuser within a clean environment, such as a data center, without creating machining debris or other contamination.

There are a number of ways to heat and air condition spaces within buildings. In many office buildings, heating and air conditioning is achieved through ducts in the ceilings of these buildings. Disadvantageously, because air for cooling a room is distributed from above, this cooled air forces warmer air residing proximate to the ceiling downward, resulting in cooling inefficiencies and a reduction in ventilation effectiveness. Ceiling-based systems also are often expensive to install, service, or modify, as a majority of the required ducting, terminals, and other equipment are located within the ceilings.

Recently, in many newer office buildings, heating and air conditioning is achieved through ducts and/or plenums provided below the floors of these buildings. Conventional floor terminals are integrated with raised floor systems in the industry by strategically installing the floor terminals within an air passageway beneath the floor. However, when each floor terminal is installed, cutting and drilling operations are used to fabricate a vertical-support system for mounting the floor terminal within the passageway. These operations generate noise, as well as dust, debris, and other airborne particles, which may disrupt workers within the building receiving floor terminals. In some settings, these airborne particles are highly problematic. For instance, a minimal amount of airborne particles generated from floor-terminal installation may prove extremely harmful for objects (e.g., network servers) and/or people (e.g., hospital patients) that occupy contamination-sensitive space.

Consequently, developing a suspension system within an air passageway underneath a raised floor and developing an installation method for mounting a floor terminal via the suspension system that does not involve drilling, cutting, or other contaminant-producing operations would cure the above-mentioned deficiencies of the conventional floor terminals. Further, it would be desirable to design a floor terminal such that, upon completion of installation, the floor terminal's operation would not generate airborne particles.

### BRIEF SUMMARY

Accordingly, embodiments of the present invention relate to an improved floor terminal (e.g., fan unit or damper unit) that is mountable via a suspension system in an air passageway beneath a raised floor. Generally, the floor terminal is used in applications where a plenum holding conditioned air exists in a subspace beneath the raised floor. Often, a grid of interconnected longitudinal and lateral rails is provided to support segments of the raised floor.

In operation, the floor terminal selectively controls an amount of the conditioned air that is emitted into a temperature-controlled space (hereinafter “room”), which is typically located immediately above the raised floor. That is, the floor terminal is functional to regulate an amount of air delivered to the room. In one instance (see FIGS. 2 and 3), the floor terminal is configured as a fan unit that operates to controllably force the conditioned air from the supply plenum to the room. In another instance (FIGS. 4 and 9-11), the floor terminal is configured as a damper unit that operates to controllably meter a pressurized flow of the conditioned air from the supply plenum to the room. The damper unit includes a frame, a plurality of rotatable gear supports (hereinafter “gears”), a plurality of vanes (e.g., closeout panels or blades) each spanning and coupling a pair of the gears, and a controls enclosure (hereinafter “housing”) for completely or partially holding a controller and a blade actuator. In embodiments, the blade actuator is configured as a stepper motor that receives instructions from the controller and rotates one or more the gears in accordance with the instructions.

Typically, the gears are internally mounted along opposed walls of the frame, and are rotatably coupled to the respective walls via any mechanism (e.g., bearings or bushings) known in the relevant field. In an exemplary embodiment, a portion of the gears coupled along a common wall are positioned linearly with respect to one another and rotatably engaged (via their teeth) to other adjacent gear(s). In an exemplary embodiment, each of the gears is composed of a nonferrous material that resists producing shavings or particles upon frictional wear of their teeth against other toothed gears that may become airborne contaminants.

The floor diffuser may be installed without the use of tools, thereby eliminating the production of contamination caused by tools. This toolless installation is facilitated by one or more hook elements that each include an upper angled portion and a lower angled portion. During installation, the upper angled portion of a hook element is inserted through an elongate aperture of a rail. Upon insertion, the upper angled portion resides within an interior space of the rail and a downwardly directed end of the upper angled portion rests upon an internal surface of a lower wall of the rail.

Further, the frame of the floor terminal is configured with downwardly-biased flanges that extend outward from a perimeter of the frame. One or more of the frame's flanges is engaged with the lower angled portion of a respective hook element upon toolless installation. In embodiments, the lower angled portion includes an upwardly directed end that contacts a respective flange of the frame upon engaging the floor terminal with the hook elements. As a result, the floor terminal is suspended within the plenum by the rails without any drilling or cutting operations.

Additional advantages and novel features of the invention will be set forth in part in a description which follows, and will become apparent to those skilled in the art upon examination of the following, or may be learned by practice of the invention.

### BRIEF DESCRIPTION OF THE SEVERAL VIEWS OF THE DRAWINGS

In the accompanying drawings which form a part of the specification and which are to be read in conjunction therewith, and in which like reference numerals are used to indicate like parts in the various views:

FIG. 1 is a fragmentary perspective view of a raised floor system having a grid of longitudinal rails and lateral rails, with portions cutaway for clarity, that support tiles which form a raised floor, in accordance with embodiments of the present invention;

FIG. 2 is a perspective view of a fan-unit type floor terminal having a frame, in accordance with embodiments of the present invention;

FIG. 3 is a fragmentary perspective view of a portion of the grid of FIG. 1, with portions cut-away for clarity, suspending the fan-unit type floor terminal of FIG. 2, in accordance with embodiments of the present invention;

FIG. 4 is perspective view of a frame of a damper-unit type floor terminal for accommodating selectively adjustable vanes, in accordance with embodiments of the present invention;

FIG. 5 is a perspective view of a hook element, in accordance with embodiments of the present invention;

FIG. 6 is a perspective view of a pair of the hook elements of FIG. 5 positioned back-to-back, in accordance with embodiments of the present invention;

FIG. 7 is a side-elevation view of the pair of hook elements of FIG. 6 positioned in a rail and resting on a lower wall of the rail, in accordance with embodiments of the present invention;

FIG. 8 is a perspective view of the assembly of FIG. 7, in accordance with embodiments of the present invention;

FIG. 9 is a perspective view of the frame of the damper-unit type floor diffuser of FIG. 4 with gears and vanes assembled to a wall of the frame, in accordance with embodiments of the present invention;

FIG. 10 is top plan view of the damper-unit type floor diffuser of FIG. 9 illustrating the vanes spanning between the gears, where the vanes are adjusted to a closed position, and with a portion of the housing cut-away, in accordance with embodiments of the present invention;

FIG. 11 is a perspective view of the damper-unit type floor diffuser of FIG. 9 with a portion cut-away to expose a controller and a blade actuator, in accordance with embodiments of the present invention; and

FIG. 12 is a flow diagram delineating a method for installing the floor terminal within a passageway beneath the raised floor, in accordance with embodiments of the present invention.

### DETAILED DESCRIPTION

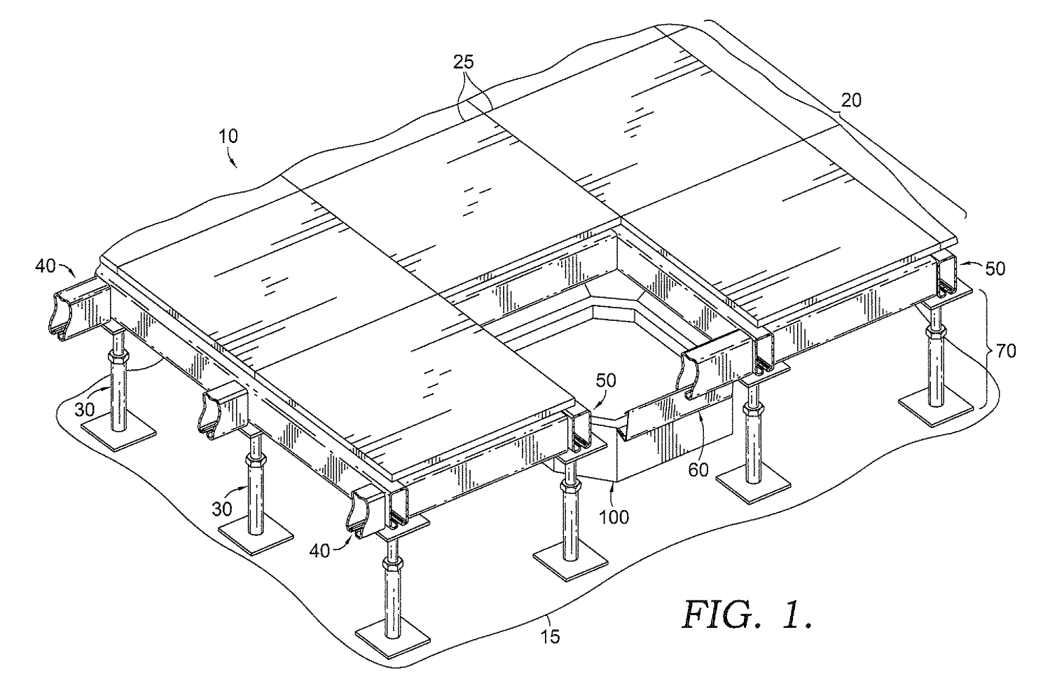

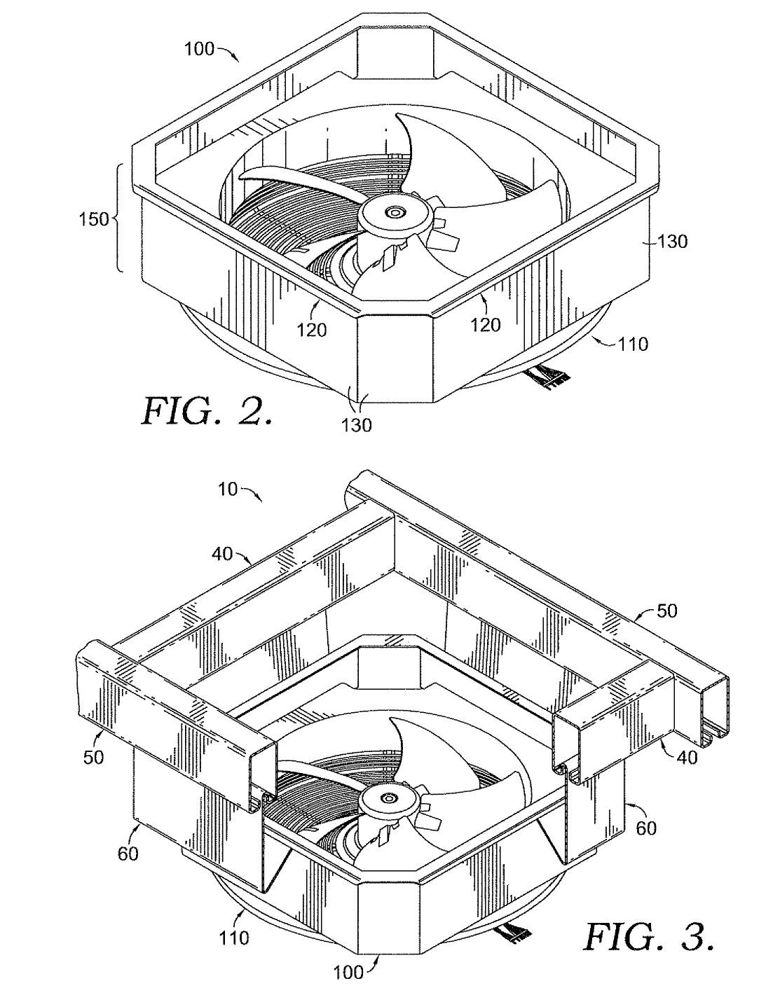

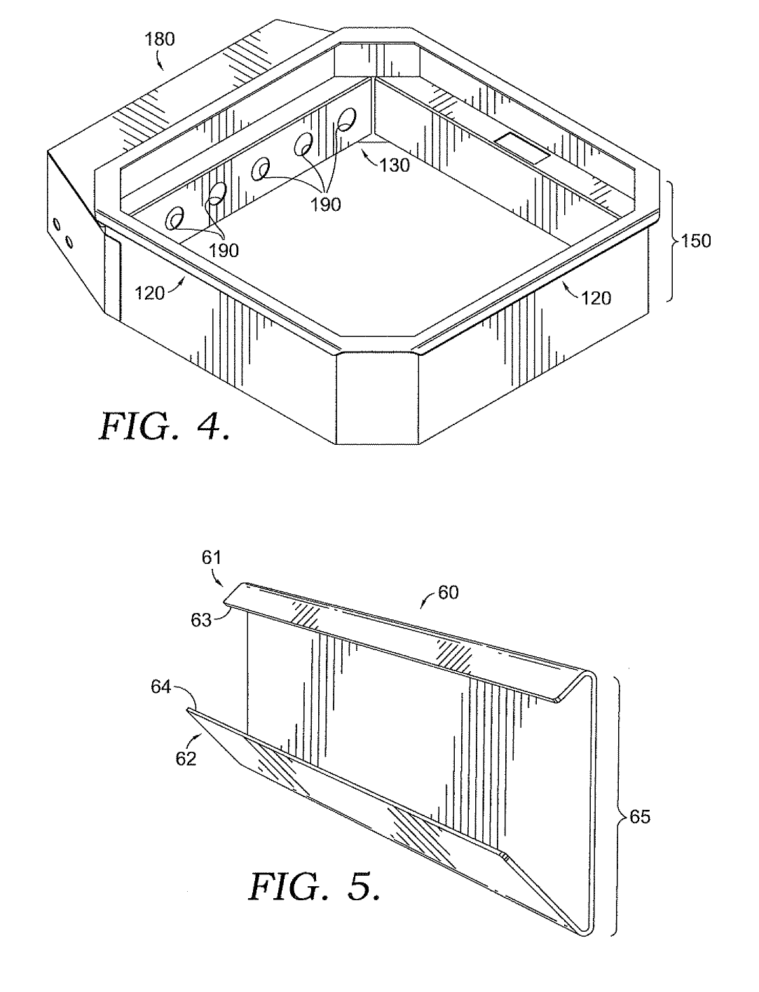

Referring to the drawings in greater detail and initially to FIG. 1, a floor terminal for use in regulating a flow of conditioned air to a temperature-controlled space (hereinafter “room”) above a raised floor 20 is shown and is designated generally by the numeral 100. With reference to FIG. 2, the floor terminal 100 includes a frame 150 comprised of walls 130. As illustrated in FIG. 2, some of the walls 130 are pronounced, or greater in size, than others. By way of example, the floor terminal 100 includes four pronounced walls 130 forming a quadrilateral, and four lesser walls 130 that exist in place of the quadrilateral's corners. Often, a plurality of downwardly-biased flanges 120 extending outwardly from the frame 150 are each positioned at one of the four pronounced sides of the frame 150, respectively, as illustrated in FIGS. 2 and 4.

In an exemplary embodiment, employing the lesser walls 130 allows an unrestricted flow of air to pass around the floor terminal 100 between a plenum below the raised floor 20 and the room. This unrestricted airflow advantageously circulates a minimal volume of conditioned air into the room without invoking actuation of the floor terminal 100. In other embodiments, the frame 150 fills an entire cavity defined by the rails 40 and 50 (see FIG. 1), thereby disallowing unrestricted airflow and ensuring that the floor terminal 100 fully regulates the distribution of the conditioned air into the room.

Typically, the walls 130 comprising the frame 150 of the floor terminal 100 shown in FIGS. 1 and 2 are generally formed from sheet metal. Although providing a single material for fabricating the floor terminal 100 is described herein, it should be understood and appreciated by those of ordinary skill in the art that other types of suitable materials that provide structure to the floor terminal 100 may be used, and that embodiments of the present invention are not limited to those materials (e.g., sheet metal) illustrated and discussed. Additionally, in certain embodiments, some walls 130 (e.g., two opposed walls) of the frame 150 are provided with apertures 190 (e.g., circular holes) that allow gears to be rotatably coupled to the walls 130, such as with bearings. Typically, these apertures 190 are formed into the frame 150 of a damper-unit type floor terminal 100 and not into the frame 150 of a fan-unit type floor terminal 100.

An embodiment of a suspension system 10 for vertically supporting the floor terminal 100 is illustrated in FIG. 1, and will now be discussed in detail. Initially, the suspension system 10 includes a grid of longitudinal rails 50 and lateral rails 40. Typically, the longitudinal rails 50 are substantially parallel-spaced and held above an underlying surface 15 by one or more stands 30. The stands 30 may be adjustable in height, thus, ensuring the raised floor 20 is level while accommodating for variances in the underlying surface 15. In an exemplary embodiment, the lateral rails 40 are substantially parallel-spaced-lateral rails and span and interconnect the longitudinal rails 50. In one instance, the longitudinal rails 50 are oriented substantially perpendicular to the lateral rails 40. A plurality of tiles or floor segments 25 are positioned on the rails 40 and 50 to create the raised floor 20.

The rails 40 and 50, in cooperation with the stands 30, hold the raised floor 20 over the underlying surface 15, thereby creating a plenum or passageway 70 under the raised floor 20 for conditioned air to reside and flow. In one instance, the passageway 70 serves as a supply plenum for distributing the conditioned air to disparate areas, or rooms, of a building. As shown, in one area where floor tile 25 is omitted, the floor terminal 100 is suspended from the rails 40 and 50 by way of hook elements 60, which will be described more fully below.

In embodiments, an exemplary temperature-controlled space, or room, may be a data center that stores multiple servers requiring a contamination-free environment. This room above the raised floor 20 is separated from the passageway 70 by the floor segments 25 that rest on an exterior surface 240 (see FIG. 8) of an upper wall 220 of at least one of the rails 40 and 50. In addition, a grate assembly (not shown) may be supported by the exterior surface 240 of the upper wall 220 of at least one of the rails 40 and 50 to cover the floor terminal 100 and permit people to walk across the raised floor 20. Typically, the grate assembly is positioned between the floor terminal 100 and an interior of the room such that its upper surface is generally flush with upper surfaces of the surrounding floor tiles 25.

In operation, the floor terminal 100 meters or pushes conditioned air through the grate assembly. Typically, the floor terminal 100 regulates flow of the conditioned air from the passageway 70 to the room immediately above the raised floor 20. That is, the floor terminal is functional to selectively control an amount of air delivered to the room. In one instance (see FIGS. 2 and 3), the floor terminal is configured as a “fan unit” that operates to controllably force the conditioned air from the supply plenum to the room. In an embodiment of the invention employing the fan-unit type floor terminal, the floor terminal 100 may regulate the flow of conditioned air using a fan mechanism 110 assembled to an interior face of one or more walls 130 of the frame 150.

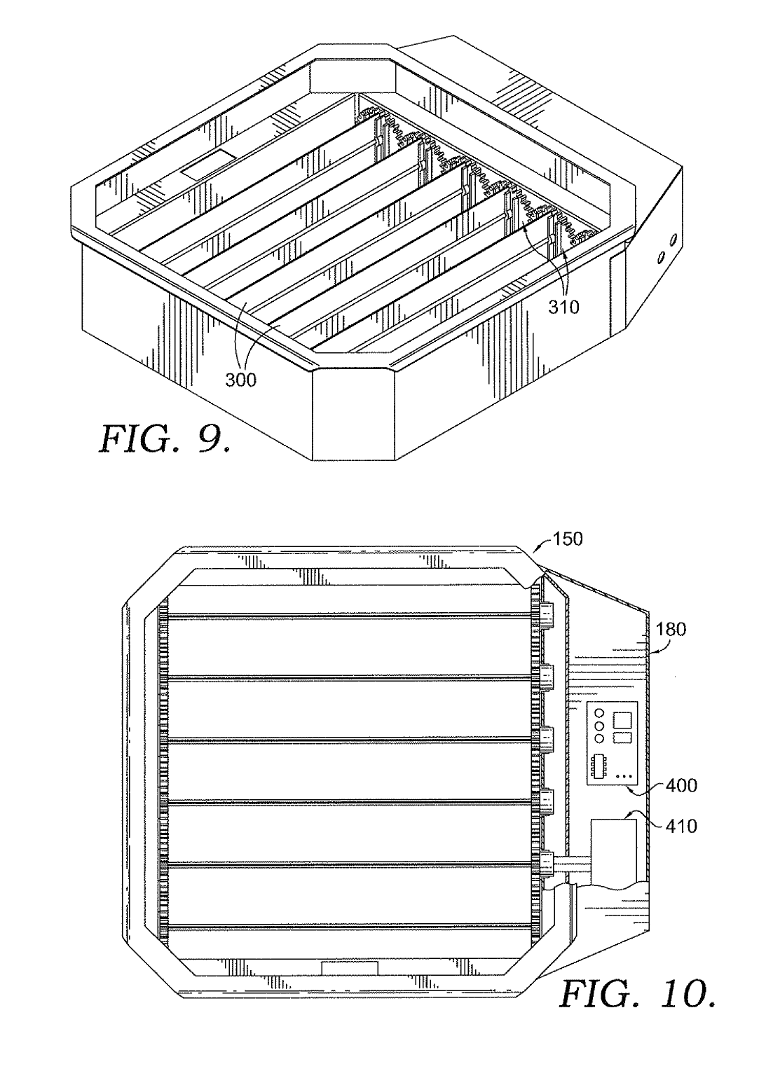

In another instance (see FIGS. 4 and 9-11), the floor terminal is configured as a “damper unit” that operates to controllably meter a pressurized flow of the conditioned air from the supply plenum to the room. In an embodiment of the invention employing the damper-unit type floor terminal, the floor terminal 100 employs a series of substantially parallel-spaced vanes 300 (see FIGS. 9 and 10) that are selectively adjusted to partially or fully block air flow therebetween. A blade actuator 410 in communicative cooperation with controller 400 (providing instructions to the blade actuator 410) facilitates selectively moving the vanes 300 from a first position (see FIG. 10) to a second position (see FIG. 9). As illustrated, the vanes are closed in the first position, such that the flow of conditioned air to the space is blocked, while the vanes are open in the second position, such that the conditioned air is applied to the space.

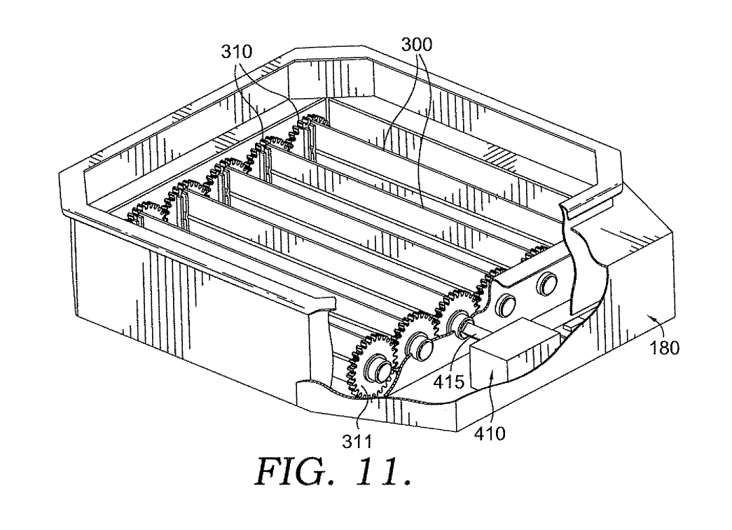

In embodiments of the damper-unit type floor terminal 100, with reference to FIG. 4, the frame 150 may be comprised of a plurality of interconnected walls 130 that define a perimeter of the frame 150. In addition, a plurality of gears 310 (see FIG. 9) may be pivotably coupled to opposed walls 130 of the frame 150, where each of the gears 310 that are located on a shared wall 130 of the frame 150 are positioned in a linear manner and rotatably-engaged to one or more adjacent gears on the shared wall. Further, each of the gears 310 faces a corresponding, typically mirror-image, gear 311 (see FIG. 11) coupled to an opposed wall 130. In an exemplary embodiment, the gears 310 and 311 are formed from a nonferrous material, such as hardened plastic or carbon fiber. Although one configuration of the nonferrous gears 310 and 311 has been described, it should be understood and appreciated that other types of suitable non-metallic materials that resist shedding particles during use may be employed, and that embodiments of the present invention are not limited to plastic-composed gears as described herein.

As discussed above, the vanes 300 may be positioned in substantial parallel-spaced relation, where each of the vanes 300 may span and interconnect a respective pair of corresponding gears 310 and 311 (see FIG. 11). An angular orientation of the vanes 300 may be manipulated by selectively rotating one or more of the gears 310 or 311. In one instance, the blade actuator 410 of FIG. 11 is operable to meter the angular orientation of the vanes 300 by rotatably adjusting one or more of the gears 310 and/or 311 in accordance with instructions conveyed from the controller 400, as mentioned above. The controller 400 generally maintains the instructions describing when and how to regulate of the conditioned air flow, using the vanes 300, based on any criteria that is measurable (e.g., room temperature, plenum air temperature, rate of air flow through the floor terminal 100, air pressure in the plenum, and the like). In embodiments, the controller 400 and the blade actuator 410 are enclosed within a housing 180 (see FIG. 10) mounted to an external surface of one or more of the walls 130 of the frame 150.

In embodiments of the present invention, the blade actuator 410 is configured as a stepper motor. When configured as a stepper motor, the blade actuator 410 includes at least one shaft 415 that is axially aligned with and coupled to at least one of the gears 310 and 311. In operation, the stepper motor selectively moves the vanes 300 from the first position (see FIG. 10) to the second position (see FIG. 9) via magnetic attraction. As indicated above, the vanes 300 are closed in the first position such that the flow of conditioned air to the space is blocked. Alternatively, the vanes 300 are open in the second position such that the conditioned air is applied to the space. Although a specific configuration of the blade actuator 410 has been described, it should be understood and appreciated by those of ordinary skill in the art that other types of suitable devices that are adaptable to incrementally or continually rotate at least one vane 300 may be used, and that embodiments of the present invention are not limited to the stepper motor described herein. For instance, the blade actuator 410 may be configured as a linear actuator that extends and retracts an element causing the gears 310 and 311 to rotate.

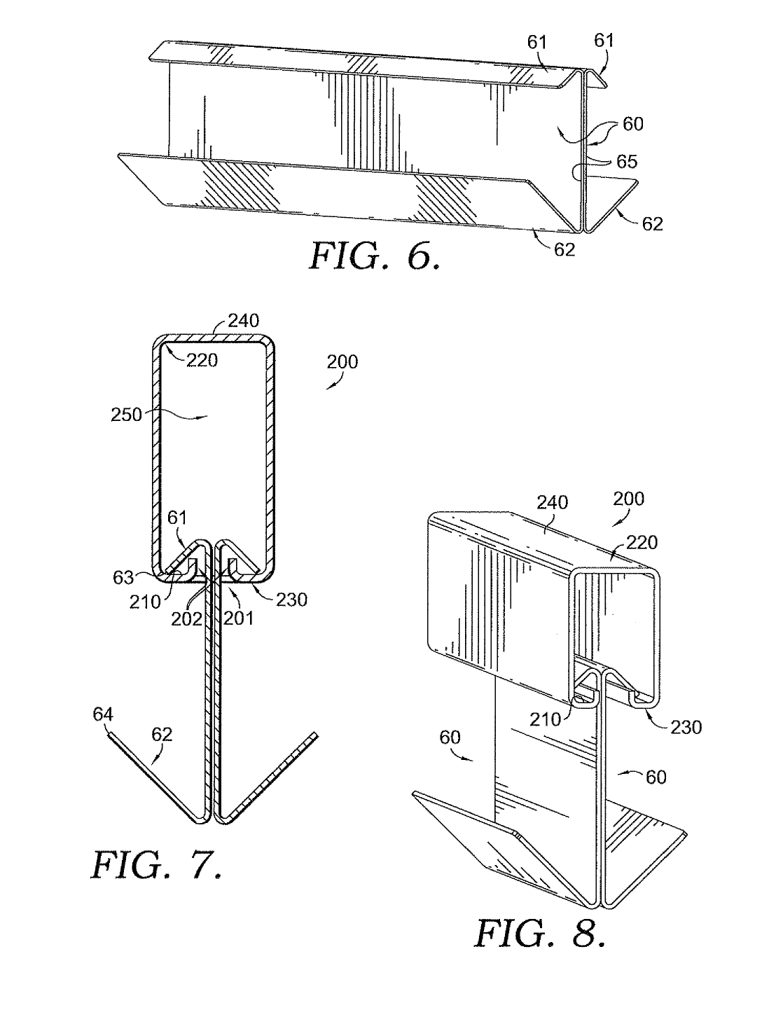

Turning now to FIGS. 5-8, the suspension system 10 to which the floor terminal 100 is installed will now be discussed. Initially, the longitudinal rails 50 and/or the lateral rails 40 are provided with an elongate aperture 201 within a lower wall 230 thereof. In an exemplary embodiment, the elongate aperture 201 is orientated linearly with the longitudinal and lateral rails 50 and 40, respectively. In that regard, while the illustrated embodiment shows elongate apertures 201 in both the longitudinal rails 50 and in the lateral rails 40, embodiments of the present invention may include elongate apertures 201 in only the longitudinal rails 50 or in only the lateral rails 40. Accordingly, as used in the claims, the phrase “one or more of the longitudinal rails and the lateral rails” covers embodiments where elongate apertures are only in the longitudinal rails 50, are only in the lateral rails 40, and are in both the longitudinal and the lateral rails 50 and 40, respectively.

The suspension system 10 also introduces the hook elements 60. As illustrated in FIG. 5, each of the hook elements 60 includes an upper-angled portion 61, a mid section 65, and a lower-angled portion 62. In an exemplary embodiment, as illustrated in FIG. 7, the upper-angled portion 61 is configured to be entirely received into an interior space 250 of the rail 200 (representing either the longitudinal rail 50 or the lateral rail 40), via the elongate aperture 201. In addition, the upper-angled portion 61 includes a downwardly-directed end 63 that rests upon an internal surface 210 of the lower wall 230. In other instances, the rail 200 includes a pair of inwardly-directed lips 202 formed at opposed edges of the elongate aperture 201. In operation, the lips 202 are adapted to securely retain the upper angled portion 61 of a respective hook element 60 within the interior 250 of one of the rails 50 and 40.

With reference to FIGS. 2-4, the frame 150 of the floor terminal 100 is configured with downwardly-biased flanges 120 that extend outward from a perimeter of the frame 150. Each of these flanges 120 is adapted to engage with the lower angled portion 62 of a respective hook element 60 (as in FIGS. 1 and 3), thereby connecting the floor terminal 100 to the longitudinal and lateral rails 50 and 40, respectively. Often, upon installation of the floor terminal 100, the upwardly-directed end 64 of each of the lower-angled portions 62 contacts either a respective wall 130 of the frame 150 upon engaging the frame's flanges 120 with the lower-angled portions 62, or contacts a respective flange 120 of the frame 150 upon engaging the floor terminal 100 with the hook elements 60.

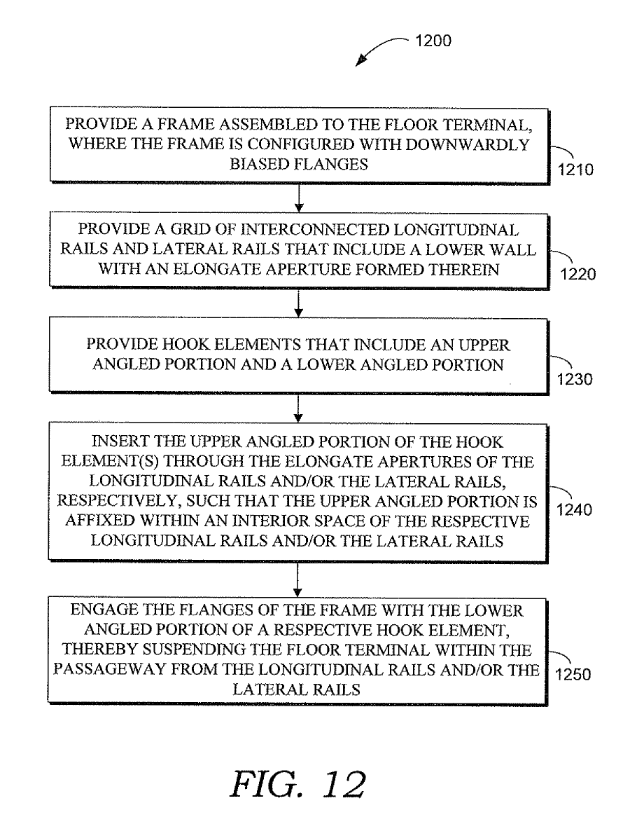

Turning now to FIG. 12, a flow diagram is illustrated that shows an overall method 1200 for installing a floor terminal within a passageway beneath a raised floor, in accordance an embodiment of the present invention. As discussed above, the passageway represents a supply plenum of conditioned air to be distributed to the room (i.e., temperature-controlled space) above the raised floor. Initially, the method 1200 involves the steps of providing a frame assembled to the floor terminal (see block 1210) and providing a grid of interconnected longitudinal rails and lateral rails (see block 1220). Typically, the frame is configured with a plurality of downwardly biased flanges that extend outward from a perimeter of the frame. Further, one or both of the longitudinal rails and the lateral rails includes a lower wall that has an elongate aperture formed therein.

As indicated at block 1230, the method 1200 involves providing a plurality of hook elements that each include an upper angled portion and a lower angled portion. Next, the upper angled portion of one or more of the hook elements is inserted through the elongate apertures of the longitudinal rails and/or the lateral rails, respectively. Upon insertion, as indicated at block 1240, the upper angled portion is affixed within an interior space of the respective longitudinal rails and/or the lateral rails. At this point, the flanges of the frame may be engaged with the lower angled portion of a respective hook element, as indicated at block 1250. Upon engagement, the floor terminal is suspended within the passageway from one or more of the longitudinal rails and/or the lateral rails.

One of ordinary skill in the art will realize that any number of steps may be employed to achieve the desired functionality within the scope of embodiments illustrated in FIG. 12. Further, although the various steps of FIG. 12 are shown with lines for the sake of clarity, in reality, delineating various components is not so clear, and metaphorically, the lines would more accurately be grey or fuzzy. Further yet, although some steps of FIG. 12 are depicted as single processes, the depictions are exemplary in nature and in number and are not to be construed as limiting.

The present invention has been described in relation to particular embodiments, which are intended in all respects to be illustrative rather than restrictive. Alternative embodiments will become apparent to those skilled in the art to which the present invention pertains without departing from its scope. It will be seen from the foregoing that this invention is one well adapted to attain the ends and objects set forth above and to attain other advantages, which are obvious and inherent in the device. It will be understood that certain features and subcombinations are of utility and may be employed without reference to other features and subcombinations. This is contemplated by and within the scope of the claims. It will be appreciated by persons skilled in the art that the present invention is not limited to what has been particularly shown and described hereinabove. Rather, all matter herein set forth or shown in the accompanying drawings is to be interpreted as illustrative and not limiting.

What is claimed is:

1. A suspension system for supporting a floor terminal within a passageway beneath a raised floor, the floor terminal having a flange extending from a frame thereof regulating a flow of conditioned air into a temperature-controlled space thereabove, the suspension system including:
substantially parallel-spaced longitudinal rails supported above an underlying surface by one or more stands;
substantially parallel-spaced lateral rails that span and interconnect the longitudinal rails, wherein one or more of the longitudinal rails and the lateral rails are provided with an elongate aperture within a lower wall thereof; and
a plurality of hook elements, wherein each of the hook elements includes an upper angled portion, a mid section, and a lower angled portion,
wherein the upper angled portion is configured to be received into an interior space of one or more of the longitudinal rails and the lateral rails, via the elongate aperture, and to rest upon an internal surface of the lower wall thereof, and
wherein the lower angled portion is configured to engage with the flange extending from the floor terminal.

2. The suspension system of claim 1, further comprising the floor terminal with the frame, wherein the frame is configured with downwardly biased flanges that extend outward from a perimeter of the frame, and wherein each of the flanges is adapted to engage with the lower angled portion of a respective hook element, thereby suspending the floor terminal from one or more of the longitudinal rails and the lateral rails.

3. The suspension system of claim 1, wherein one or more of the longitudinal rails and the lateral rails includes a pair of inwardly directed lips formed at opposed edges of the elongate aperture, wherein the lips are adapted to securely retain the upper angled portion of a respective hook element within the interior of one of the longitudinal rails or the lateral rails.

4. The suspension system of claim 1, wherein the elongate aperture is orientated linearly with one or more of the longitudinal rails and the lateral rails, respectively.

5. The suspension system of claim 1, further comprising a grate assembly that is supported by an exterior surface of an upper wall of the longitudinal rails and the lateral rails, wherein the grate assembly is positioned between the floor terminal and the temperature controlled space.

6. The suspension system of claim 2, wherein the mid section of the hook elements is of sufficient length such that, upon installation of the floor terminal to the hook elements, a top of the frame resides below the lower wall of each of the longitudinal rails and the lateral rails.

7. A method for installing a floor terminal within a passageway beneath a raised floor, the passageway representing a supply plenum of conditioned air to be distributed to a temperature-controlled space above the raised floor, the floor terminal having a frame configured with a plurality of downwardly biased flanges that extend outward from a perimeter of the frame, and the raised floor being supported by a grid of interconnected longitudinal rails and lateral rails, wherein one or more of the longitudinal rails and the lateral rails includes a lower wall that has an elongate aperture formed therein,
the method comprising: providing a plurality of hook elements, wherein each of the hook elements includes an upper angled portion and a lower angled portion;
inserting the upper angled portion of one or more of the hook elements through the elongate apertures of the one or more of the longitudinal rails and the lateral rail such that the upper angled portion is affixed within an interior space of the one ore more of the longitudinal rails and the lateral rails; and
engaging the flanges of the frame with the lower angled portion of a respective hook element, thereby suspending the floor terminal within the passageway from one or more of the longitudinal rails and the lateral rails.

8. The method of claim 7, wherein each of the lower angled portions includes an upwardly directed end that contacts a respective flange of the frame upon engaging the floor terminal with the hook elements.

9. The method of claim 7, wherein each of the upper angled portions include a downwardly directed end that that rests upon an internal surface of a respective lower wall of the longitudinal rails and the lateral rails upon affixing the hook elements thereto.

10. The method of claim 7, wherein the longitudinal rails and the lateral rails comprise at least a pair of longitudinal rails in substantial parallel-spaced relation and a pair of lateral rails in substantial parallel-spaced relation, and wherein the longitudinal rails are orientated in substantial perpendicular-spaced relation with respect to the lateral rails.

11. The method of claim 7, wherein the frame is configured with four pronounced sides, and wherein the plurality of downwardly facing flanges include four flanges that are each positioned at one of the four pronounced sides of the frame.

12. The method of claim 7, wherein each of the longitudinal rails and the lateral rails includes an upper wall for vertically supporting a grate assembly or a segment of the raised floor and wherein each of the longitudinal rails and the lateral rails have elongate apertures formed in lower walls thereof.

13. The method of claim 7, wherein the floor terminal is configured as a fan unit that operates to controllably force the conditioned air from the supply plenum to the temperature-controlled space.

14. The method of claim 7, wherein the floor terminal is configured as a damper unit that operates to controllably meter a pressurized flow of the conditioned air from the supply plenum to the temperature-controlled space.

15. A floor terminal for regulating a flow of conditioned air from a supply plenum beneath a raised floor into a temperature-conditioned space above the raised floor, wherein the floor terminal comprises:
a frame with a plurality of interconnected walls that define a perimeter of the frame;
a plurality of gears that are rotatably coupled to opposed walls of the frame, wherein a portion of the gears that are located on a shared wall of the frame are positioned in a linear manner, and wherein the each of the gears faces a corresponding gear coupled to the opposed wall and rotatably engages one or more adjacent gears on the shared wall;
a plurality of vanes positioned in substantial parallel-spaced relation, wherein each of the vanes spans and interconnects a respective pair of corresponding gears; and
a controls enclosure coupled one or more of the walls of the frame, wherein the controls enclosure serves to partially enclose a controller and a blade actuator.

16. The floor terminal of claim 15, wherein the controller maintains instructions for the regulation of the conditioned-air flow, and wherein the blade actuator is operable to meter an angular orientation of the vanes by rotatably adjusting one or more of the gears in accordance within the instructions conveyed from the controller.

17. The floor terminal of claim 15, wherein the plurality of gears are composed of a nonferrous material.

18. The floor terminal of claim 17, wherein the blade actuator is configured as a stepper motor.

19. The floor terminal of claim 18, wherein the stepper motor selectively moves the vanes from a first position to a second position via magnetic attraction.

20. The floor terminal of claim 19, wherein the vanes are closed in the first position such that the flow of conditioned air to the space is blocked, and wherein the vanes are open in the second position such that the conditioned air is applied to the space.
